(19) United States
(12) Patent Application Publication
(10) Pub. No.: US 2022/0390919 A1
(43) Pub. Date: Dec. 8, 2022

(54) PRODUCTION FACILITY MONITORING SYSTEM, PRODUCTION FACILITY MONITORING METHOD, AND PRINTING SYSTEM

(71) Applicant: Konica Minolta, Inc., Tokyo (JP)

(72) Inventor: Takashi Ajioka, Tokyo (JP)

(73) Assignee: Konica Minolta, Inc., Tokyo (JP)

(21) Appl. No.: 17/740,357

(22) Filed: May 10, 2022

(30) Foreign Application Priority Data
Jun. 3, 2021 (JP) 2021-093820

(51) Int. Cl. G05B 19/406; G05B 13/02

(52) U.S. Cl. CPC G05B 19/406; G05B 13/0265; G05B 2219/32293

(57) ABSTRACT

A production facility monitoring system includes: an information acquirer that acquires information on productivity of one or more production facilities; an information manager that extracts, based on one or more results included in a statistical result of the acquired information, a proposal item satisfying a condition of the statistical result from at least one proposal-item reference table containing proposal items; and a display that displays the extracted proposal item. The production facility monitoring system monitors the productivity.

### CROSS-REFERENCE TO RELATED APPLICATIONS

The present application claims priority from Japanese patent Application No. 2021-093820, filed on Jun. 3, 2021, the contents of which are incorporated herein by reference in its entirety.

### BACKGROUND

### Technological Field

The present invention relates to a production facility monitoring system, a production facility monitoring method, and a printing system.

### Description of the Related Art

In order to improve the productivity of various production facilities, it is required to grasp a process status in the production facilities. The process status can be grasped by various process monitoring systems that are typically widespread. As one of the factors affecting the productivity of such a production facility, the operation rate of the production facility can be mentioned in addition to the process status.

A technique of calculating an operation rate as one of factors affecting the productivity of a production facility is disclosed in JP 2009-211256 A. Specifically, disclosed in JP 2009-211256 A is a technique of calculating an interruption time due to an error during execution of a job and not including the interruption time in the operation rate calculation of printing so that the operation rate can be calculated on the basis of the execution time.

Meanwhile, as factors affecting the productivity of a production facility, an in-process problem item and a performance problem item can be mentioned in addition to the process status and the operation rate. However, when it is assumed that a worker finds an in-process problem item or a performance problem item as an infrequent factor, the burden on the worker is high. Furthermore, the domain knowledge (i.e., knowledge specialized in a specific field) of the worker is required to solve the problem. As a result, the productivity of the production facility may be reduced.

### SUMMARY

One or more embodiments provide a production facility monitoring system, a production facility monitoring method, and a printing system that enable improvement of the productivity of production facilities.

The production facility monitoring system according to one or more embodiments monitors productivity of at least one production facility and comprises: an information acquirer that acquires information on the productivity of the at least one production facility; an information manager that extracts, with reference to one or a plurality of proposal-item reference tables containing a plurality of proposal items for presentation to a user, based on one result or a combination of a plurality of results included in a statistical result of specific information acquired by the information acquirer, a proposal item satisfying a condition of the statistical result; and a display that displays the proposal item extracted by the information manager.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic configuration diagram of an exemplary printing system to which the technology of one or more embodiments is applied;

FIG. 2 is a block diagram schematically illustrating the configuration of a production facility monitoring system according to one or more embodiments;

FIG. 3 is a flowchart illustrating an exemplary processing procedure of a production facility monitoring method according to one or more embodiments;

FIG. 4 is a block diagram illustrating an exemplary configuration of an information acquirer in a case where a production facility is a printing apparatus; and

FIG. 5 is an exemplary proposal-item reference table that allows reference of a plurality of proposal items from characteristic items in the case where the production facility is the printing apparatus.

### DETAILED DESCRIPTION

Hereinafter, embodiments of the present invention will be described with reference to the drawings. However, the scope of the invention is not limited to the disclosed embodiments. In the present specification and the drawings, constituent elements having substantially the same functions or configurations are denoted with the same reference signs, and thus the redundant description is not given.

<Printing System>

In the present specification, a printing system to which the technology of one or more embodiments of the present invention (production facility monitoring system or production facility monitoring method) is applied will be described as an example. The printing system is constructed by disposing one or a plurality of printing apparatus as an exemplary production facility. The printing system is used, for example, in a printing company that prints a large number of catalogs, fliers, and the like. In the present specification, a printing apparatus will be described as an exemplary production facility; however, the production facility is not limited to the printing apparatus.

[Exemplary Configuration of Printing System]

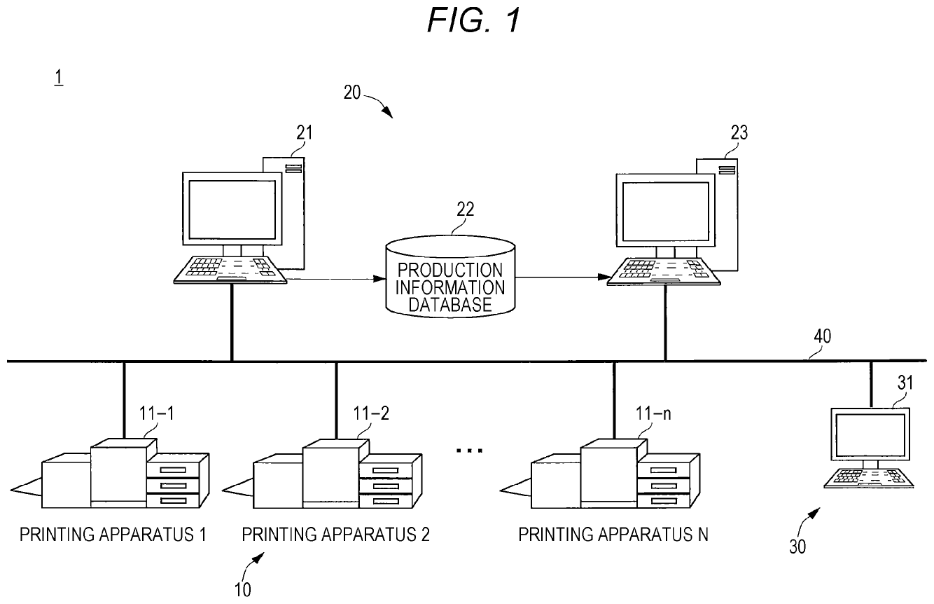

FIG. 1 is a schematic configuration diagram of an exemplary printing system.

As illustrated in FIG. 1, a printing system 1 according to the present application example includes a printer 10, an information manager 20, and a display 30. The printer 10, the information manager 20, and the display 30 are communicable with each other through a network 40 such as the Internet or a local area network.

The printer 10 includes a plurality (N number) of printing apparatuses 11 (11-1 to 11-n). Here, a case where the plurality of printing apparatuses 11-1 to 11-n is exemplified as printing apparatuses 11; however, the number of printing apparatuses is not limited to two or more and thus may be one. As the printing apparatuses 11 (11-1 to 11-n), printing apparatuses (image forming apparatuses) each having a known configuration can be provided.

The printing apparatuses 11 (11-1 to 11-n) are each, for example, an electrophotographic image forming apparatus, and are each an apparatus capable of forming images such as catalogs and fliers on various recording materials. With the printing apparatuses 11 (11-1 to 11-n), such recording materials each on which an image can be formed are sheet-like, and are materials such as plain paper, thick paper, thin paper, Japanese paper, and special paper various in material property, basis weight, thickness, and size.

The information manager 20 includes an information collection-acquisition server 21, a production information database 22, and an information analysis server 23. The information manager 20 collectively manages the N number of printing apparatuses 11-1 to 11-n through a cloud, for example. Note that, here, the information manager 20 collectively manages the N number of printing apparatuses 11-1 to 11-n through the cloud; however, the information manager 20 can be disposed in each of the N number of printing apparatuses 11-1 to 11-n. The details of the information collection-acquisition server 21, the production information database 22, and the information analysis server 23 will be described later.

The display 30 includes a display 31 of a personal computer, for example, and displays information on the N number of printing apparatuses 11-1 to 11-n managed by the information manager 20. Note that, here, the display 30 includes the display 31 of the single personal computer; however, in a case where each of the printing apparatuses 11-1 to 11-n is equipped with a monitor (display), the monitor can be used as a display 30.

In the printing system 1 having the above configuration, examples of factors that affects the productivity of the printing apparatuses 11 (11-1 to 11-n) each as an exemplary production facility include an in-process problem item and a performance problem item. However, when it is assumed that a worker (operator) finds an in-process problem item or a performance problem item, the burden on the worker is high and the domain knowledge of the worker for solving the problem is required, which may cause a decrease in the productivity of the production facility.

The production facility monitoring system and the production facility monitoring method according to one or more embodiments described below have been made in view of such a situation, that is, in order to suppress the burden on the worker (operator) and improve the productivity without requiring the domain knowledge of the worker.

<Production Facility Monitoring System According to Embodiments>

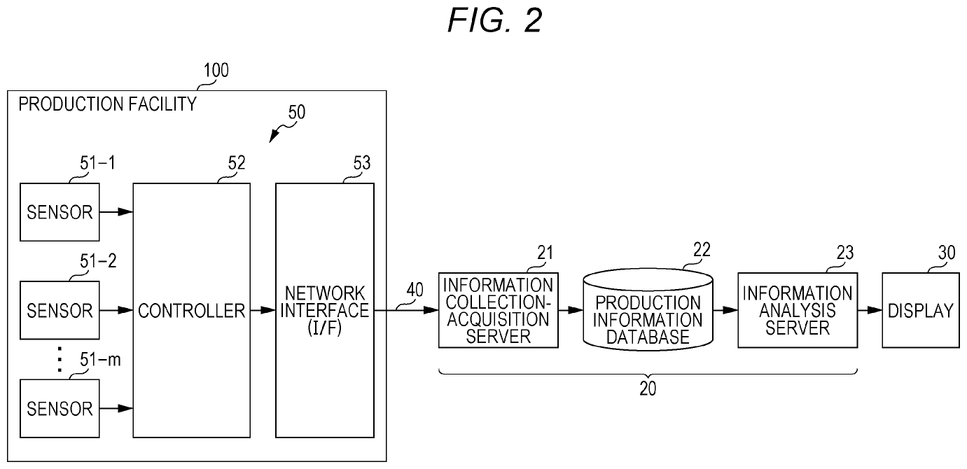

FIG. 2 is a block diagram schematically illustrating the configuration of the production facility monitoring system according to one or more embodiments. The production facility monitoring system according to one or more embodiments described below has a function of presentation of a tip for process improvement to the user (worker or operator) for a production facility such as a printing apparatus.

FIG. 2 illustrates a system configuration including a single production facility for simplification of description; however, the number of production facilities is required to be at least one. Further, the printing apparatuses 11 (11-1 to 11-n) described above can be each exemplified as a production facility; however, the production facility is not limited to the printing apparatuses 11 (11-1 to 11-n).

The production facility monitoring system according to one or more embodiments includes a production facility 100, an information manager 20, and a display 30. The production facility 100, the information manager 20, and the display 30, respectively, correspond to the printer 10, the information manager 20, and the display 30 of the printing system 1 described above.

The production facility 100 includes an information acquirer 50 that acquires information on the productivity of the production facility 100. The information acquirer 50 includes a plurality of sensors 51-1 to 51-m, a controller 52, and a network interface (I/F) 53.

The plurality of sensors 51-1 to 51-m each acquires various types of information on the productivity of the production facility 100. The controller 52 includes a central processing unit (CPU), a random access memory (RAM), a read only memory (ROM) (not illustrated here), and performs control to acquire information on the productivity of the production facility 100 according to a processing program stored in the ROM. The network interface 53 transmits information output from the controller 52 to the information manager 20 through a network 40.

As the information on the productivity of the production facility 100, exemplified can be information such as an operation log and an error log, more specifically, information such as productivity, an operation time, an error type, and the number of times of each error.

The information manager 20 holds in advance the result of statistical processing of numerical values stratified in a plurality of ranges, and uses, in comparison in a coefficient of variation for each of the numerical values between production facilities, a production facility having the largest numerical value as a target to be extracted from a proposal-item reference table to be described later. This configuration enables determination which production facility is suitable when a proposal item (e.g., a sentence) is extracted from the proposal-item reference table.

Specifically, the information manager 20 includes an information collection-acquisition server 21, a production information database 22, and an information analysis server 23, and manages the production facility 100 through a cloud, for example. Note that, here, the information manager 20 manages the production facility 100 through the cloud; however, the information manager 20 may be disposed in the production facility 100.

The information collection-acquisition server 21 collects the information on the productivity of the production facility 100 acquired by the information acquirer 50 in the production facility 100. The production information database 22 stores the information on the productivity of the production facility 100 collected by the information collection-acquisition server 21. The information analysis server 23 analyzes the information on the productivity of the production facility 100 stored in the production information database 22. The information analysis server 23 extracts, with reference to one or a plurality of proposal-item reference tables for presentation to the user (operator), on the basis of one result or a combination of a plurality of results included in the statistical result of specific information, a proposal item satisfying a condition of the statistical result, and then outputs the proposal item to the display 30. A specific example of such a proposal-item reference table will be described later.

The display 30 includes, for example, a display 31 of a personal computer, and displays the proposal item satisfying the condition of the statistical result supplied from the information analysis server 23 in document form and provides (presents) the document to the user (operator).

<Production Facility Monitoring Method According to Embodiments>

Next, a production facility monitoring method according to one or more embodiments performed in the production facility monitoring system having the above configuration will be specifically described. The processing of the production facility monitoring method is analysis processing of information on the productivity of production facilities 100, which is performed, in the information analysis server 23, under the control of the CPU included in the information analysis server 23.

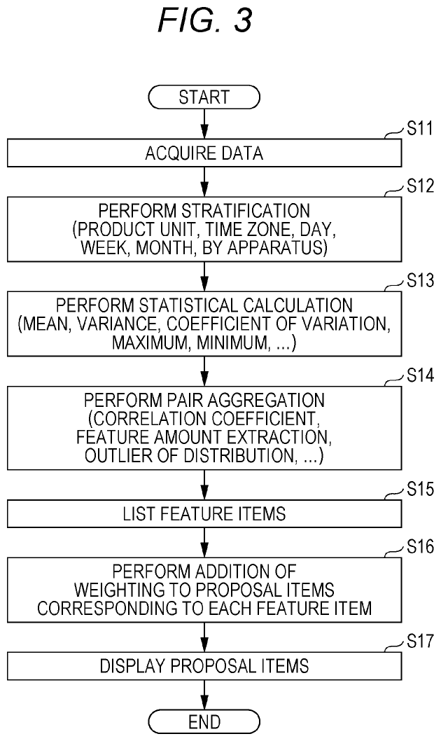

FIG. 3 is a flowchart illustrating an exemplary processing procedure of the production facility monitoring method according to one or more embodiments.

Prior to the analysis processing of the information on the productivity of the production facilities 100 as described above, the CPU included in the information analysis server 23 (hereinafter, simply referred to as “CPU”) first acquires data regarding the information on the productivity of the production facilities 100 collected by the information collection-acquisition server 21 and stored in the production information database 22 (step S11).

Next, the CPU performs stratification by product unit, time zone, day, week, month, apparatus, and others (step S12). Then, CPU performs statistical processing (statistical calculation) such as mean, variance, coefficient of variation, maximum, and minimum (step S13). Specifically, in steps S12 and S13, as the statistical processing, performed is processing in which the result of statistical processing of numerical values stratified in a plurality of ranges is temporarily placed in a storage or a database in advance and, in comparison in a coefficient of variation for each of the numerical values between the production facilities, a production facility having the largest value is used as a target to be extracted from a proposal-item reference table.

Next, the CPU performs pair aggregation on all statistical values due to statistical processing, such as a correlation coefficient, a feature amount extraction, and an outlier of a distribution, and selects a parameter to be used, with a machine learning technique (step S14). Then, the CPU lists feature items (step S15), and performs addition of weighting to proposal items corresponding to each feature item (step S16).

Next, on the basis of the addition result of the weighting, the CPU causes the display 30 to display the proposal items in document form in descending order of weight (step S17). The display of the proposal items enables presentation of tips for process improvement to the user (worker or operator). Thus, the series of processing for the analysis processing of the information on the productivity of the production facilities 100 ends.

As described above, with the production facility monitoring system or the production facility monitoring method according to one or more embodiments, an infrequent factor of such a production facility can be identified, so that a tip (improvement action) for process improvement to the infrequent factor can be presented in document form to the user (worker or operator) as a proposal item. In such a manner, the presentation of the tips for the process improvement to the user enables a reduction in burden on the user and elimination of the need for the domain knowledge of the user, resulting in improvement of the productivity of the production facility.

Further, pair aggregation on all statistical values due to statistical processing is performed, and a parameter to be used is selected with a machine learning technique. As a result, in extraction of a proposal item (e.g., sentence), a more effective proposal item as a parameter to be improved can be determined.

<Example of Case where Production Facility is Printing Apparatus>

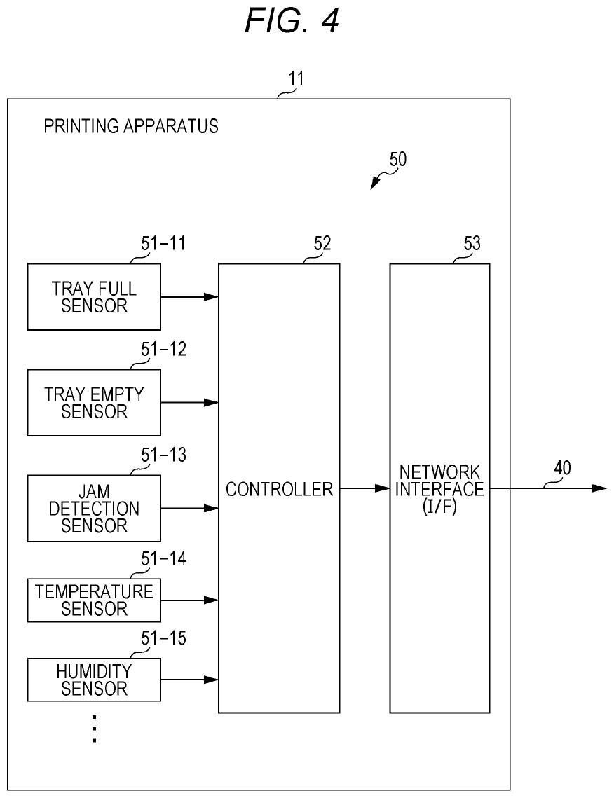

Here, a case where such a production facility 100 is the printing apparatus 11 described above will be described as an example. FIG. 4 is a block diagram illustrating an exemplary configuration of the information acquirer 50 in the case where the production facility 100 is the printing apparatus 11.

Inside the printing apparatus 11, various sensors such as a tray full sensor 51-11, a tray empty sensor 51-12, a jam detection sensor 51-13, a temperature sensor 51-14, and a humidity sensor 51-15 are provided as measuring devices. Note that the various sensors exemplified here are merely examples and are not limited to these sensors, and thus other sensors may be provided.

The tray full sensor 51-11 detects that the number of sheets stacked on a sheet discharge tray has reached the number of stackable sheets, and notifies the controller 52 of the detection result. The tray empty sensor 51-12 detects that a sheet feeding tray is empty, and notifies the controller 52 of the detection result. The jam detection sensor 51-13 detects that a paper jam has occurred in a sheet conveyance path, and notifies the controller 52 of the detection result. The temperature sensor 51-14 detects the internal temperature of the printing apparatus 11, and notifies the controller 52 of the detection result. The humidity sensor 51-15 detects the internal humidity of the printing apparatus 11, and notifies the controller 52 of the detection result.

The controller 52 performs control to acquire information on the productivity of the printing apparatus 11 on the basis of the detection results of, for example, the tray full sensor 51-11, the tray empty sensor 51-12, the jam detection sensor 51-13, the temperature sensor 51-14, and the humidity sensor 51-15. Specifically, the controller 52 finds out that the sheet discharge tray is in the full tray state in which the sheet discharge tray is full on the basis of the detection result of the tray full sensor 51-11, and finds out that the sheet feeding tray is in the paper empty state in which the sheet feeding tray is empty on the basis of the detection result of the tray empty sensor 51-12.

The controller 52 further finds out that a paper jam has occurred in the sheet conveyance path, on the basis of the detection result of the jam detection sensor 51-13, and finds out the state of the temperature and humidity inside the printing apparatus 11 on the basis of the detection results of the temperature sensor 51-14 and the humidity sensor 51-15. A peripheral environment such as the temperature and humidity inside the printing apparatus 11 may affect occurrence of a paper jam in the sheet conveyance path.

[Specific Example of Proposal-Item Reference Table]

Here, given will be a specific example of a proposal-item reference table that is referred to when the information analysis server 23 extracts a proposal item to be proposed to the user (operator) in the case where the production facility 100 is the printing apparatus 11. Note that at a site where a plurality of printing apparatuses 11-1 to 11-n is disposed, a single operator manages several printing apparatuses (two to three as an example) as a unit.

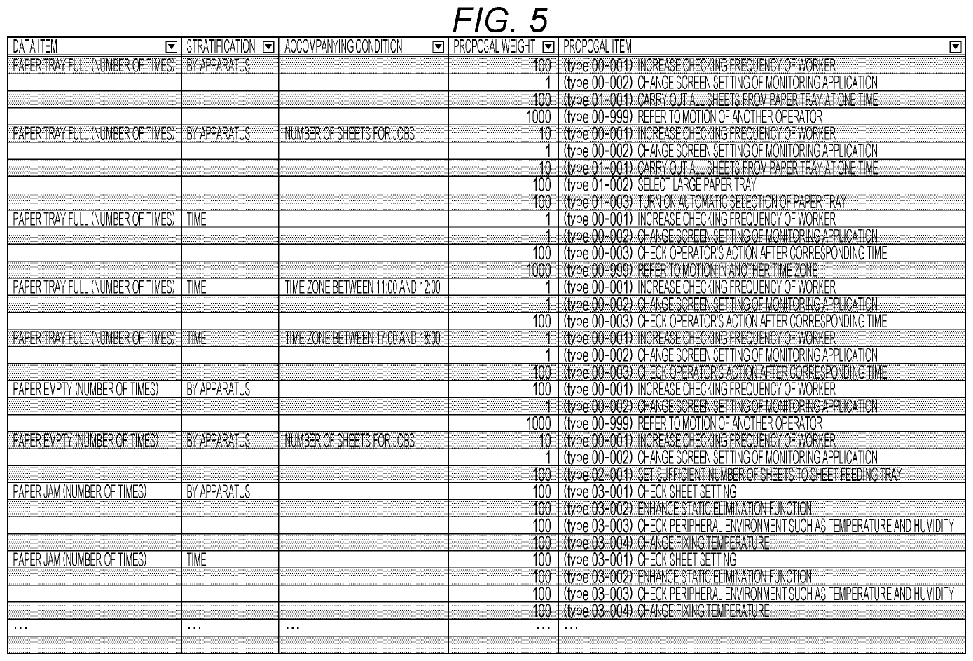

FIG. 5 is an exemplary proposal-item reference table that allows reference of a plurality of proposal items from characteristic items in the case where the production facility is the printing apparatus. The proposal-item reference table illustrated in FIG. 5, indicates, for example, a data item, stratification, an accompanying condition, a proposal weight, and a proposal item. The data item is an infrequent factor of the printing apparatus exemplified below, which is identified from the operation log data of the printing apparatus 11.

As such data items as infrequent factors, exemplified can be a paper tray full (number of times) in which the sheet discharge tray is full, paper empty (number of times) in which the sheet feeding tray is empty, and paper jam (number of times). Examples of the stratification include by apparatus and time. The time includes a time zone, a date, and a day of the week. Examples of the accompanying condition include the number of sheets for jobs and a time zone (e.g., between 11:00 and 12:00 or between 17:00 and 18:00). Here, as examples, 1, 10, 100, and 1000 are each listed as a proposal weight.

As is clear from the proposal-item reference table illustrated in FIG. 5, each of such items contained in the proposal-item reference table has a weight, and each proposal content to which the condition corresponds is added with the corresponding weight. In extraction of a proposal item for presentation to the operator (worker) of the printing apparatus, with reference to the proposal-item reference table illustrated in FIG. 5, the information analysis server 23 prioritizes, in descending order of weighting, the proposal items contained in the proposal-item reference table, for display on the display 30.

The information analysis server 23 performs pair aggregation on all statistical values due to statistical processing, and selects a parameter to be used, with a machine learning technique. Then, the information analysis server 23 makes an increase in weighting on a proposal item using the selected parameter. As a result, can be given priority to a proposal item with higher importance.

Hereinafter, given will be examples of a proposal item for presentation of an improvement action for an identified infrequent factor of the printing apparatus to the user (worker or operator) with reference to one or a plurality of proposal-item reference tables.

Proposal items for the data item as paper tray full (number of times) and the stratification as by apparatus

When the proposal weight is 100, the proposal item corresponds to (type 00-001) increase the checking frequency of the worker. When the proposal weight is 1, the proposal item corresponds to (type 00-002) change the screen setting of the monitoring application. When the proposal weight is 100, the proposal item corresponds to (type 01-001) carry out all the sheets from the paper tray (sheet discharge tray) at one time. When the proposal weight is 1000, the proposal item corresponds to (type 00-999) refer to the motion of another operator.

Proposal items for the data item as paper tray full (number of times), the stratification as by apparatus, and the accompanying condition as the number of sheets for jobs.

When the proposal weight is 10, the proposal item corresponds to (type 00-001) increase the checking frequency of the worker. When the proposal weight is 1, the proposal item corresponds to (type 00-002) change the screen setting of the monitoring application. When the proposal weight is 10, the proposal item corresponds to (type 01-001) carry out all the sheets from the paper tray (sheet discharge tray) at one time. When the proposal weight is 100, the proposal item corresponds to (type 01-002) select the large paper tray. When the proposal weight is 100, the proposal item corresponds to (type 01-003) turn on the automatic selection of the paper tray.

Proposal items for the data item as paper tray full (number of times) and the stratification as time.

When the proposal weight is 1, the proposal item corresponds to (type 00-001) increase the checking frequency of the worker. When the proposal weight is 1, the proposal item corresponds to (type 00-002) change the screen setting of the monitoring application. When the proposal weight is 100, the proposal item corresponds to (type 00-003) check the operator's action after the corresponding time. When the proposal weight is 1000, the proposal item corresponds to (type 00-999) refer to motion in another time zone.

Proposal items for the data item as paper tray full (number of times), the stratification as time, and the accompanying condition as time zone between 11:00 and 12:00 (incidentally, in the time zone between 11:00 and 12:00, it is easy to relax before lunch break)

When the proposal weight is 1, the proposal item corresponds to (type 00-001) increase the checking frequency of the worker. When the proposal weight is 1, the proposal item corresponds to (type 00-002) change the screen setting of the monitoring application. When the proposal weight is 100, the proposal item corresponds to (type 00-003) check the operator's action after the corresponding time.

Proposal items for the data item as paper tray full (number of times), the stratification as time, and the accompanying condition as time zone between 17:00 and 18:00 (incidentally, in the time zone between 17:00 and 18:00, it is easy to relax before the end of work)

When the proposal weight is 1, the proposal item corresponds to (type 00-001) increase the checking frequency of the worker. When the proposal weight is 1, the proposal item corresponds to (type 00-002) change the screen setting of the monitoring application. When the proposal weight is 100, the proposal item corresponds to (type 00-003) check the operator's action after the corresponding time.

Proposal items for the data item as paper empty (number of times), the stratification as by apparatus, and the accompanying condition as the number of sheets for jobs When the proposal weight is 10, the proposal item corresponds to (type 00-001) increase the checking frequency of the worker. When the proposal weight is 1, the proposal item corresponds to (type 00-002) change the screen setting of the monitoring application. When the proposal weight is 100, the proposal item corresponds to (type 00-999) refer to the motion of another operator.

Proposal items for the data item as paper empty (number of times) and the stratification as by apparatus

When the proposal weight is 100, the proposal item corresponds to (type 00-001) increase the checking frequency of the worker. When the proposal weight is 1, the proposal item corresponds to (type 00-002) change the screen setting of the monitoring application. When the proposal weight is 100, the proposal item corresponds to (type 02-001) set the sufficient number of sheets to the sheet feeding tray.

Proposal items for the data item as paper jam (number of times) and the stratification as by apparatus

When the proposal weight is 100, the proposal item corresponds to (type 03-001) check the sheet setting, (type 03-002) enhance the static elimination function, (type 03-003) check the peripheral environment such as temperature and humidity, or (type 03-004) change the fixing temperature.

Proposal items for the data item as paper jam (number of times) and the stratification as time

When the proposal weight is 100, the proposal item corresponds to (type 03-001) check the sheet setting, (type 03-002) enhance the static elimination function, (type 03-003) check the peripheral environment such as temperature and humidity, or (type 03-004) change the fixing temperature.

As described above, with reference to one or a plurality of proposal-item reference tables, a plurality of proposal items can be extracted on the basis of an infrequent factor as a feature item of the printing apparatus. For example, in a case where the number of times of paper tray full is larger on a specific day of the week for a specific printing apparatus, in the one or the plurality of proposal-item reference tables, the data item corresponds to paper tray full (number of times) and the stratification corresponds to by apparatus, and the data item corresponds to paper tray full (number of times) and the stratification corresponds to time. Therefore, type 00-001, type 00-002, type 01-001, type 00-999, type 00-003, and type 00-999 in the one or the plurality of proposal-item reference tables correspond to the proposal items. The corresponding four proposal items are displayed on the display 30. As a result, the proposal items displayed on the display 30 can be proposed to the user (worker/operator) as the improvement actions for the infrequent factor. When weighting is performed by simple addition, type 00-999 is preferentially displayed.

As described above, for a printing apparatus as an exemplary production facility, infrequent factors of the printing apparatus such as paper tray full, paper empty, and paper jam can be identified, and tips (improvement actions) for process improvement to the infrequent factors can be presented in document format to the user (worker or operator) as proposal items. In such a manner, the presentation of the tips for process improvement to the user enables a reduction in burden on the user and elimination of the need for the domain knowledge, resulting in improvement of the productivity of the production facility.

<Modifications>

Note that the present invention is not limited to the above embodiments, and it is obvious that various other applications and modifications can be made without departing from the gist of the present invention described in the claims. For example, the above embodiments describe the configuration of the system in detail and specifically in order to describe the present invention in an easy-to-understand manner, and thus is not necessarily limited to those having all the described configurations. Addition, deletion, and replacement of other configurations can be made for part of the configuration of one or more embodiments.

Further, in the above embodiments, a printing apparatus has been described as an exemplary production facility. The production facility, however, is not limited to the printing apparatus, and thus may be a post-processing work apparatus or the like in addition to the printing apparatus. The post-processing work apparatus is a work apparatus that performs, for example, processing of forming a punch hole, processing of stapling, processing of forming a marking image, processing of sheet shredding (cutting) on a sheet printed and output by the printing apparatus.

Furthermore, in the above embodiments, an infrequent factor of the printing apparatus is identified under the control of the information manager 20, and a tip for process improvement to the infrequent factor is presented to the user as a proposal item. However, display of a list of statistical values due to statistical processing can prompt the user to select a proposal item, so that an increase can be made in weighting of a proposal-item reference table regarding a selected parameter.

Although embodiments of the present invention have been described and illustrated in detail, the disclosed embodiments are made for purposes of illustration and example only and not limitation. The scope of the present invention should be interpreted by terms of the appended claims.

What is claimed is:

1. A production facility monitoring system comprising:
an information acquirer that acquires information on productivity of one or more production facilities;
an information manager that extracts, based on one or more results included in a statistical result of the acquired information, a proposal item satisfying a condition of the statistical result from at least one proposal-item reference table containing proposal items; and
a display that displays the extracted proposal item, wherein
the production facility monitoring system monitors the productivity.

2. The production facility monitoring system according to claim 1, wherein the information manager:
holds in advance a result of statistical processing of numerical values stratified in ranges, compares a coefficient of variation for each of the numerical values between the production facilities, and targets one of the production facilities having a largest numerical value in extracting the proposal item.

3. The production facility monitoring system according to claim 1, wherein
each of the proposal items has a weight, and
the information manager:
adds the weight corresponding to the proposal item satisfying the condition, and
prioritizes the proposal items in descending order of weighting to display.

4. The production facility monitoring system according to claim 1, wherein the information manager:
performs pair aggregation on all statistical values due to statistical processing, and
selects a parameter to be used with machine learning.

5. The production facility monitoring system according to claim 4, wherein the information manager increases a weight on one of the proposal items using the selected parameter.

6. The production facility monitoring system according to claim 1, wherein
the display displays a list of statistical values due to statistical processing to select one of the proposal items, and
the information manager increases a weight of the at least one proposal-item reference table regarding a selected parameter.

7. A production facility monitoring method comprising:
monitoring productivity of at least one production facility;
acquiring information on the productivity of the at least one production facility;
extracting, based on one or more results included in a statistical result of the acquired information, a proposal item satisfying a condition of the statistical result from at least one proposal-item reference table containing proposal items; and
displaying the extracted proposal item.

8. A printing system comprising:
at least one printing apparatus; and
a production facility monitoring system that monitors productivity of the at least one printing apparatus, wherein the production facility monitoring system comprises:
an information acquirer that acquires information on the productivity of the at least one printing apparatus;
an information manager that extracts, based on one or more results included in a statistical result of the acquired information, a proposal item satisfying a condition of the statistical result from at least one proposal-item reference table containing proposal items; and
a display that displays the extracted proposal item.
